(19) United States
(12) Patent Application Publication
(10) Pub. No.: US 2013/0213898 A1
(43) Pub. Date: Aug. 22, 2013

(54) LIQUID PROCESSING APPARATUS AND METHODS FOR PROCESSING LIQUIDS

(71) Applicant: Ronald Paul Grunwald, JR., Albuquerque, NM (US)

(72) Inventor: Ronald Paul Grunwald, JR., Albuquerque, NM (US)

(21) Appl. No.: 13/400,493

(22) Filed: Feb. 20, 2012

(51) Int. Cl. C02F 1/48

(52) U.S. Cl. 210/748.01; 210/243

(57) ABSTRACT

A liquid processing apparatus is provided. The apparatus includes a cylindrical tube that includes an inner portion configured to contain a liquid therein and an outer portion substantially circumscribing the inner portion. The outer portion includes a porous filter. A conductive assembly is coupled to the cylindrical tube, wherein the conductive assembly is configured to generate an electric field to apply on the liquid. The liquid is channeled from the inner portion of the cylindrical tube through the conductive assembly such that the liquid is filtered when the liquid is channeled through the porous filter and sterilized when the liquid is channeled through the conductive assembly.

### BACKGROUND OF THE INVENTION

The field of the invention relates generally to beverage industrial systems and, more particularly, to a liquid processing apparatus for use in industrial systems, such as beverage or liquid industrial systems.

At least some known liquid or beverage industrial systems produce and/or process liquid products, such as milk, juice, or, in the case of breweries, beer. Such liquid products undergo various processing techniques, involving two or three steps, before the liquid products are made available to consumers. The first step includes removing solid particles from the liquid using sedimentation or centrifugation. For example, in the processing and production of beer, centrifugation may be used to remove yeast and protein from the liquid. Similarly, centrifugation may be used for the clarification of milk. The second step generally involves the filtering of the liquid. For example, a polyethersulfone membrane or a silica filter may be used for the sterile filtration of beer and/or wine. The third step generally involves the liquid being pasteurized. For example, milk or beer may be heated for a certain time period to inhibit microbial growth in the milk or beer. Only after these steps are completed, can the liquid be available to consumers.

However, these steps require a significant amount of time, energy, and resources. For example, having three steps for each of the processing techniques is time consuming. Moreover, each step requires its own holding area. For example, a different and distinct apparatus is required for each of the filtering step and the sterilization step. The use of each of these holding areas requires a significant amount of energy. For example, a pump may be required to channel the liquid from each holding area for each step. Moreover, the silica filters used during the filtering step may be a health hazard.

### BRIEF DESCRIPTION OF THE INVENTION

In one embodiment, a liquid processing apparatus is provided. The apparatus includes a cylindrical tube that includes an inner portion configured to contain a liquid therein and an outer portion substantially circumscribing the inner portion. The outer portion includes a porous filter. A conductive assembly is coupled to the cylindrical tube, wherein the conductive assembly is configured to generate an electric field to apply on the liquid. The liquid is channeled from the inner portion of the cylindrical tube through the conductive assembly such that the liquid is filtered when the liquid is channeled through the porous filter and sterilized when the liquid is channeled through the conductive assembly.

In another embodiment, a liquid processing apparatus is provided. The apparatus includes a cylindrical tube that includes an inner portion configured to contain a liquid therein and an outer portion substantially circumscribing the inner portion. The outer portion includes a porous filter and a conductive material embedded within the porous filter. The liquid is channeled from the inner portion to the outer portion such that the liquid is filtered and sterilized when the liquid is channeled through the porous filter. A container substantially circumscribes the cylindrical tube, wherein the container is configured to receive the liquid after the liquid is channeled through the cylindrical tube.

In yet another embodiment, an industrial system is provided. The system includes a power supply configured to generate electrical energy and a liquid processing apparatus coupled to the power supply. The liquid processing apparatus includes a cylindrical tube that includes an inner portion configured to contain a liquid therein and an outer portion substantially circumscribing the inner portion. The outer portion includes a porous filter. A conductive assembly is coupled to the cylindrical tube and is configured to receive electrical energy from the power supply, wherein the conductive assembly is further configured to generate an electric field to apply on the liquid. The liquid is channeled from the inner portion of the cylindrical tube through the conductive assembly such that the liquid is filtered when the liquid is channeled through the porous filter and sterilized when the liquid is channeled through the conductive assembly.

In yet another embodiment, a method of processing a liquid is provided. A cylindrical tube coupled to a conductive assembly is provided, wherein the cylindrical tube includes an inner portion and an outer portion that includes a porous filter substantially circumscribing the inner portion, and wherein the conductive assembly is configured to generate an electric field to apply on the liquid. The liquid is distributed within the inner portion of the cylindrical tube such that the liquid is contained therein. The liquid is channeled from the inner portion through the conductive assembly such that the liquid is filtered when the liquid is channeled through the porous filter and sterilized when the liquid is channeled through the conductive assembly.

### BRIEF DESCRIPTION OF THE DRAWINGS

FIG. 1 is a block diagram of an exemplary industrial system;

FIG. 2 is a schematic of an upstream view of an exemplary liquid processing apparatus that may be used with the industrial system shown in FIG. 1 and taken along line 2-2;

FIG. 3 is a schematic of an upstream view of an alternative liquid processing apparatus that may be used with the industrial system shown in FIG. 1 and taken along line 2-2; and

FIG. 4 is a schematic of an upstream view of another alternative liquid processing apparatus that may be used with the industrial system shown in FIG. 1 and taken along line 2-2.

### DETAILED DESCRIPTION OF THE INVENTION

The exemplary apparatus, systems, and methods described herein overcome at least some known disadvantages associated with at least some known industrial systems. More specifically, the embodiments described herein provide a liquid processing apparatus that facilitates a liquid to be filtered and sterilized in the apparatus at the same time. As such, the filtration process and the sterilization process occur together and liquid or beverage industrial systems will no longer need separate holding areas to perform the filtration and the pasteurization or sterilization. Accordingly, liquid processing by beverage industrial systems may no longer require a significant amount of time, energy, and resources.

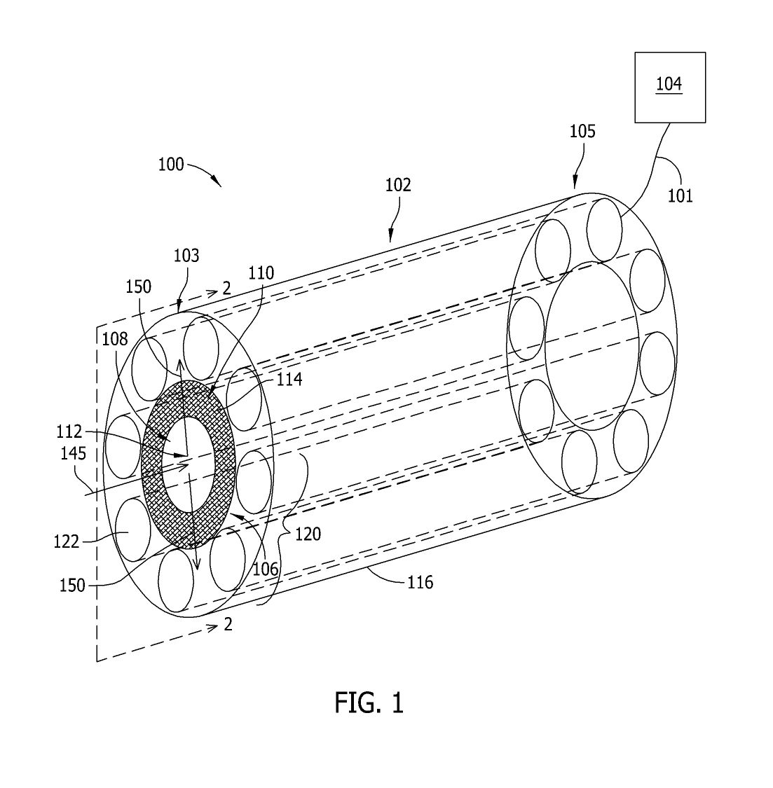

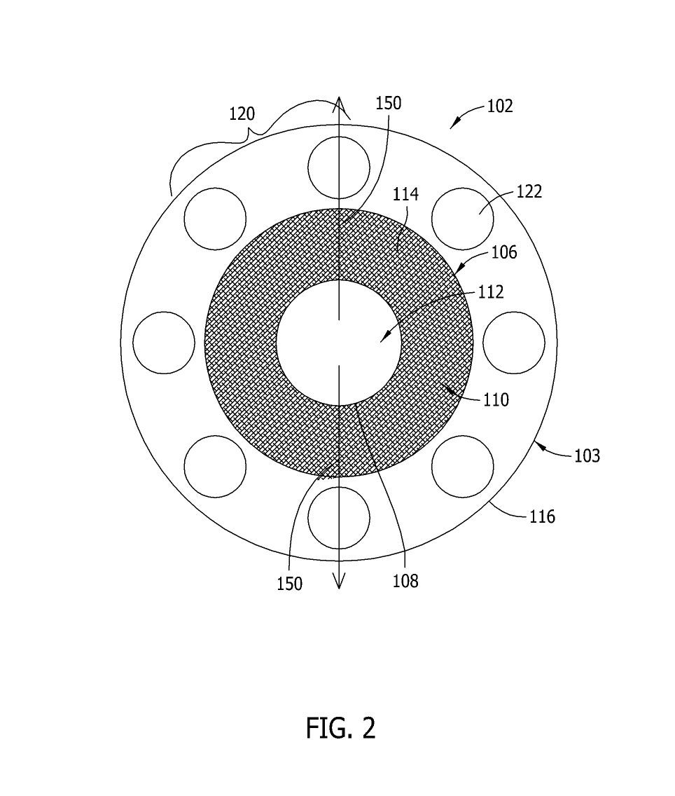

FIG. 1 illustrates an industrial system 100. FIG. 2 illustrates an upstream view of a liquid processing apparatus 102 used with industrial system 100 and taken along line 2-2 (shown in FIG. 1). In the exemplary embodiment, industrial system 100 is a brewing system for beer. While the exemplary embodiment includes a liquid or beverage industrial system that is a brewing system for beer, the present disclosure is not limited to any one particular liquid or beverage industrial system or to any particular type of liquid, and one of ordinary skill in the art will appreciate that the current disclosure may be used in connection with other types of beverage industrial systems and/or other types of industrial systems for various types of fluids, including various types of liquids.

System 100 includes a power supply 104 coupled to liquid processing apparatus 102 via a conduit 101. In the exemplary embodiment, power supply 104 may be any type of device configured to transmit electrical energy to at least one electric load (not shown) within liquid processing apparatus 102. For example, power supply 104 may be an electrical energy transmission system, such as a power supply that converts AC line voltage to DC voltage, an energy storage device, such as a battery and fuel cells, or elecromechanical systems, such as a generator or an alternator. The power supply will develop high voltage, short duration pulses.

In the exemplary embodiment, liquid processing apparatus 102 has a first end 103 and a second end 105, wherein second end 105 is enclosed (not shown) such that second end 105 may be positioned directly on a surface, such as a floor (not shown) within system 100. Moreover, liquid processing apparatus 102 includes a cylindrical tube 106 extending from apparatus first end 103 to apparatus second end 105, wherein cylindrical tube 106 has an inner portion 108 and an outer portion 110 that substantially circumscribes inner portion 108. Inner portion 108, in the exemplary embodiment, defines an opening 112 that extends axially from apparatus first end 103 to apparatus second end 105 such that a liquid, such as beer, may be distributed and contained within inner portion 108. More specifically, liquid may be poured into opening 112 at apparatus first end 103, and liquid may be distributed within inner portion 108 from apparatus first end 103 to apparatus second end 105, as shown by arrow 145.

Outer portion 110, in the exemplary embodiment, includes a porous filter 114, such that the liquid is filtered when the liquid is channeled therethrough. More specifically, in the exemplary embodiment, porous filter 114 may be any suitable filter that is sized to be received within outer portion, such as an annular filter cartridge or sheet that extends from apparatus first end 103 to apparatus second end 105. In the exemplary embodiment, porous filter 114 may include at least one membrane (not shown), such as a polyethersulfone (PESU) membrane, having a pore size of between about 0.1 micron to about 0.45 micron. Alternatively, porous filter 114 may include any other type of suitable porous membrane that may be fabricated from organic materials, such as polymers and liquids, as well as inorganic materials having a suitable pore size.

In the exemplary embodiment, liquid processing apparatus 102 also includes a container 116 substantially circumscribing at least a portion of cylindrical tube 106. More specifically, in the exemplary embodiment, container 116 is substantially cylindrical and sized to receive cylindrical tube 106 therein such that container 116 substantially encloses at least a portion of cylindrical tube 106 therein. Moreover, container 116 is also configured to contain and store liquid therein when liquid is channeled from inner portion 108 of cylindrical tube 106 to container 116. Alternatively, container 116 may be any other suitable shape that enables liquid processing apparatus 102 and/or system 100 to function as described herein.

Moreover, liquid processing apparatus 102, in the exemplary embodiment, includes a conductive assembly 120 coupled to cylindrical tube 106 and to power supply 104. More specifically, in the exemplary embodiment, conductive assembly 120 includes a plurality of substantially cylindrical shaped rods 122 positioned within container 116 such that rods 122 substantially circumscribe cylindrical tube 106. Alternatively, rods 122 may be positioned in any other portion of liquid processing apparatus 102 and/or arranged in any other suitable manner with respect to cylindrical tube 106 that enables liquid processing apparatus 102 and/or system 100 to function as described herein. In the exemplary embodiment, each rod 122 extends from apparatus first end 103 to apparatus second end 105. Alternatively, rods 122 may extend to any other portion of apparatus 102. Further, in the exemplary embodiment, each rod 122 is fabricated of a conductive material, including but not limited to stainless steel, copper, and/or aluminum.

In the exemplary embodiment, conductive assembly 120 is configured to generate an electric field to apply on the liquid such that the liquid is sterilized via a non-thermal process. More specifically, in the exemplary embodiment, each rod 122 is configured to generate a pulsed electric field (PEF) to apply onto the liquid. For example, each rod 122 is configured to generate the electric field to apply the electric field in exponentially decaying pulses, square wave pulses, bipolar pulses, and/or oscillatory pulses on the liquid such that energy is transmitted to the liquid. The electric field emitted by each rod 122 may be controlled via a controller (not shown) that is communicatively coupled to conductive assembly 120. The controller may, for example, be a real-time controller that includes any suitable processor-based or microprocessor-based system, such as a computer system, that includes microcontrollers, reduced instruction set circuits (RISC), application-specific integrated circuits (ASICs), logic circuits, and/or any other circuit or processor that is capable of executing the functions described herein. In one embodiment, the controller may be a microprocessor that includes read-only memory (ROM) and/or random access memory (RAM), such as, for example, a 32 bit microcomputer with 2 Mbit ROM and 64 Kbit RAM. As used herein, the term “real-time” refers to outcomes occurring in a substantially short period of time after a change in the inputs affect the outcome, with the time period being a design parameter that may be selected based on the importance of the outcome and/or the capability of the system processing the inputs to generate the outcome.

During operation, unprocessed liquid, such as unfiltered and unsterilized beer, may be poured into liquid processing apparatus 102. More specifically, in the exemplary embodiment, the liquid may be poured into opening 112 defined within cylindrical tube inner portion 108 at apparatus first end 103. The liquid may be distributed within inner portion 108 from apparatus first end 103 to apparatus second end 105, and stored therein. Power supply 104 may then transmit electrical energy to liquid processing apparatus 102 via conduit 101. More specifically, electrical energy is transmitted, via power supply 104, to conductive assembly 120.

The liquid is then channeled outwardly from inner portion 108 to container 116 in a cross-flow direction, as shown by arrows 150. In the exemplary embodiment, the liquid is channeled outwardly from inner portion 108 to outer portion 110, wherein the liquid is filtered when the liquid is channeled through porous filter 114. Filter 114 prevents semi-liquid and/or solid particles, such as yeast, hops, or grain particles, that are dispersed within the liquid from being channeled therethrough. The filtered liquid is then channeled outwardly from outer portion 110 to container 116.

Conductive assembly 120 positioned within container 116 facilitates the sterilization of the filtered liquid. More specifically, the electrical energy transmitted from power supply 104 enables each rod 122 to be electrically charged. Then each rod 122 generates and applies a pulsed electric field onto the liquid. The electric field applies energy onto the liquid for each pulse. As such, micro-organisms or spores within the filtered liquid are terminated. The filtered and sterilized liquid may remain and be stored within container 116 until later use.

Accordingly, as the liquid is channeled within liquid processing apparatus 102, the liquid can be filtered and sterilized at the same time. Further, system 100 does not need a holding area to perform the step of filtering and a separate holding area to perform the step of sterilization. As a result, system 100 may not require a significant amount of time, energy, and resources for processing the liquid.

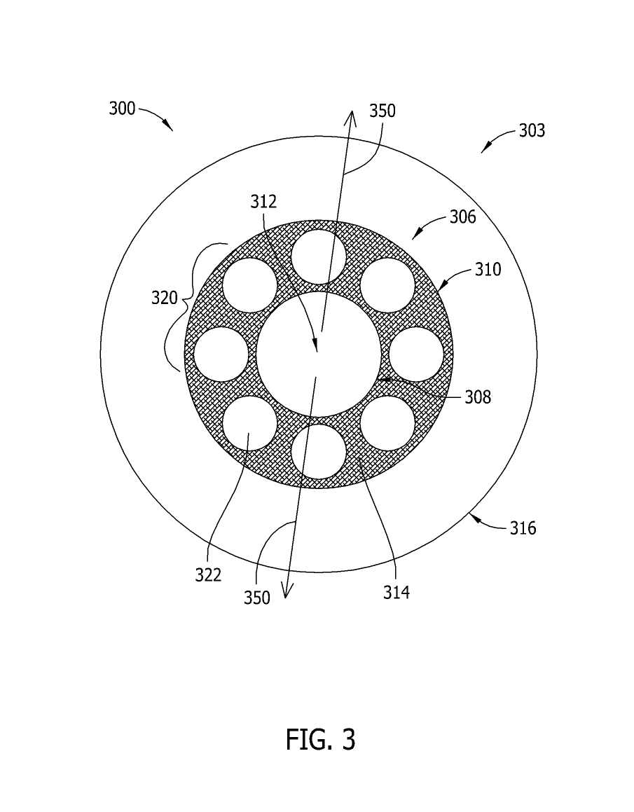

FIG. 3 is an upstream view of a liquid processing apparatus 300 that may be used with industrial system 100 (shown in FIG. 1) and taken along line 2-2 (shown in FIG. 1) in place of liquid processing apparatus 102 (shown in FIGS. 1 and 2). In the exemplary embodiment, liquid processing apparatus 300 has a first end 303 and a second end (not shown), wherein the second end is enclosed (not shown) such that the second end may be positioned directly on a surface, such as the floor within system 100. Moreover, liquid processing apparatus 300 includes a cylindrical tube 306 extending from apparatus first end 303 to the apparatus second end, wherein cylindrical tube 306 has an inner portion 308 and an outer portion 310 that substantially circumscribes inner portion 308. Inner portion 308, in the exemplary embodiment, defines an opening 312 that extends axially from apparatus first end 303 to the apparatus second end such that a liquid, such as beer, may be distributed and contained within inner portion 308. More specifically, liquid may be poured into opening 312 at apparatus first end 303 and liquid may be distributed within inner portion 308 from apparatus first end 303 to the apparatus second end.

Outer portion 310, in the exemplary embodiment, includes a porous filter 314, such that the liquid is filtered when the liquid is channeled therethrough. More specifically, in the exemplary embodiment, porous filter 314 may be any suitable filter that is sized to be received within outer portion, such as an annular filter cartridge or sheet that extends from apparatus first end 303 to the apparatus second end. In the exemplary embodiment, porous filter 314 may include, for example, at least one polyethersulfone (PESU) membrane (not shown) having a pore size of between about 0.1 micron to about 0.45 micron. Alternatively, porous filter 314 may include any type of suitable porous membrane that may be fabricated from organic materials, such as polymers and liquids, as well as inorganic materials having a suitable pore size.

In the exemplary embodiment, liquid processing apparatus 300 also includes a container 316 substantially circumscribing at least a portion of cylindrical tube 306. More specifically, in the exemplary embodiment, container 316 is substantially cylindrical and sized to receive cylindrical tube 306 therein such that container 316 substantially encloses at least a portion of cylindrical tube 306 therein. Moreover, container 316 is configured to contain and store liquid therein when liquid is channeled from inner portion 308 of cylindrical tube 306 to container 316. Alternatively, container 316 may be any other suitable shape that enables liquid processing apparatus 300 and/or system 100 to function as described herein.

Moreover, liquid processing apparatus 300, in the exemplary embodiment, includes a conductive assembly 320 coupled to cylindrical tube 306 and to power supply 104 (shown in FIG. 1). More specifically, in the exemplary embodiment, conductive assembly 320 includes a plurality of substantially cylindrical shaped rods 322 positioned within outer portion 310 of cylindrical tube 306 such that rods 322 substantially circumscribe inner portion 308 of cylindrical tube 306. In the exemplary embodiment, each rod 322 extends from apparatus first end 303 to the apparatus second end. Alternatively, rods 322 may extend to any other portion of apparatus 300. Further, in the exemplary embodiment, each rod 322 is fabricated of a conductive material, including but not limited to, stainless steel, copper, and/or aluminum.

In the exemplary embodiment, conductive assembly 320 is configured to generate an electric field to apply on the liquid such that the liquid is sterilized via a non-thermal process. More specifically, in the exemplary embodiment, each rod 322 is configured to generate a pulsed electric field (PEF) to apply onto the liquid. For example, each rod 322 is configured to generate the electric field to apply the electric field in exponentially decaying pulses, square wave pulses, bipolar pulses, and/or oscillatory pulses on the liquid such that energy is transmitted to the liquid. The electric field emitted by each rod 322 may be controlled via the controller.

During operation, unprocessed liquid, such as unfiltered and unsterilized beer, may be poured into liquid processing apparatus 300. More specifically, in the exemplary embodiment, the liquid may be poured into opening 312 defined within cylindrical tube inner portion 308 at apparatus first end 303. The liquid may be distributed within inner portion 308 from apparatus first end 303 to the apparatus second end, and stored therein. Power supply 104 may then transmit electrical energy to liquid processing apparatus 300 via conduit 101 (shown in FIG. 1). More specifically, electrical energy is transmitted, via power supply 104, to conductive assembly 322.

The liquid is then channeled outwardly from inner portion 308 to container 316 in a cross-flow direction, as shown by arrows 350, such that the liquid may be filtered and sterilized. In the exemplary embodiment, the liquid is channeled outwardly from inner portion 308 to outer portion 310. The liquid is then filtered and sterilized in outer portion 310. More specifically, in the exemplary embodiment, filter 314 prevents semi-liquid and/or solid particles, such as yeast, hops, or grain particles, that are dispersed within the liquid from being channeled therethrough. Further, conductive assembly 320 positioned within outer portion 308 facilitates the sterilization of the liquid at the same time. More specifically, the electrical energy transmitted from power supply 104 enables each rod 322 to be electrically charged. Then each rod 322 generates and applies a pulsed electric field onto the liquid. The electric field applies energy onto the liquid for each pulse. As such, micro-organisms or spores within the filtered liquid are terminated. The filtered and sterilized liquid is then channeled to container 316, wherein the liquid may remain and be stored until later use.

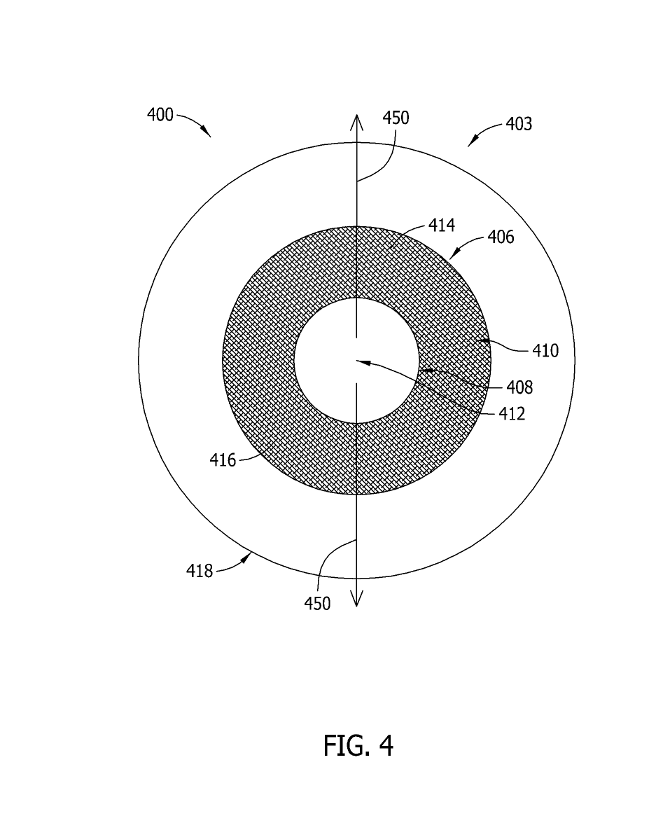

FIG. 4 is an upstream view of a liquid processing apparatus 400 that may be used with industrial system 100 (shown in FIG. 1) and taken along line 2-2 (shown in FIG. 1) in place of liquid processing apparatus 102 (shown in FIGS. 1 and 2). In the exemplary embodiment, liquid processing apparatus 400 has a first end 403 and a second end (not shown), wherein the second end is enclosed (not shown) such that the second end may be positioned directly on a surface, such as the floor within system 100. Moreover, liquid processing apparatus 400 includes a cylindrical tube 406 extending from apparatus first end 403 to the apparatus second end, wherein cylindrical tube 406 has an inner portion 408 and an outer portion 410 that substantially circumscribes inner portion 408. Inner portion 408, in the exemplary embodiment, defines an opening 412 that extends axially from apparatus first end 403 to the apparatus second end such that a liquid, such as beer, may be distributed and contained within inner portion 408. More specifically, liquid may be poured into opening 412 at apparatus first end 403 and liquid may be distributed within inner portion 408 from apparatus first end 403 to the apparatus second end.

Outer portion 410, in the exemplary embodiment, includes a porous filter 414, such that the liquid is filtered when the liquid is channeled therethrough. More specifically, in the exemplary embodiment, porous filter 414 may be any suitable filter that is sized to be received within outer portion, such as an annular filter cartridge or sheet that extends from apparatus first end 403 to the apparatus second end. In the exemplary embodiment, porous filter 414 may include, for example, at least one polyethersulfone (PESU) membrane (not shown) having a pore size of between about 0.1 micron to about 0.45 micron. Alternatively, porous filter 414 may include any type of suitable porous membrane that may be fabricated from organic materials, such as polymers and liquids, as well as inorganic materials having a suitable pore size.

In the exemplary embodiment, a conductive material 416 is embedded within filter 414 such that the liquid can also be sterilized when the liquid is channeled through filter 414. More specifically, conductive material 416 may be a sintered metal that is configured to be a cathode within filter 414. Alternatively, conductive material 416 may be any other suitable material that enables liquid processing apparatus 400 to function as described herein. In the exemplary embodiment, the conductive material 416 is configured to generate an electric field to apply onto the liquid. More specifically, conductive material 416 is configured to apply the electric field in exponentially decaying pulses, square wave pulses, bipolar pulses, and/or oscillatory pulses on the liquid such that between approximately 10 to 100 Joules of energy is transmitted to the liquid. The electric field emitted by conductive material 416 may be controlled via the controller.

In the exemplary embodiment, liquid processing apparatus 400 also includes a container 418 substantially circumscribing at least a portion of cylindrical tube 406. More specifically, in the exemplary embodiment, container 418 is fabricated such that container is an anode to facilitate the generation of electric fields with conductive material 416. Moreover, container 418 is substantially cylindrical and sized to receive cylindrical tube 406 therein such that container 418 substantially encloses at least a portion of cylindrical tube 406 therein. Moreover, container 418 is configured to contain and store liquid therein when liquid is channeled from inner portion 408 of cylindrical tube 406 to container 418. Alternatively, container 418 may be any other suitable shape that enables liquid processing apparatus 400 and/or system 100 to function as described herein.

During operation, unprocessed liquid, such as unfiltered and unsterilized beer, may be poured into liquid processing apparatus 400. More specifically, in the exemplary embodiment, the liquid may be poured into opening 412 defined within cylindrical tube inner portion 408 at apparatus first end 403. The liquid may be distributed within inner portion 408 from apparatus first end 403 to the apparatus second end, and stored therein. Power supply 104 may then transmit electrical energy to liquid processing apparatus 400 via conduit 101 (shown in FIG. 1). More specifically, electrical energy is transmitted, via power supply 104, to container 418 and/or to cylindrical tube outer portion 410.

The liquid is then channeled outwardly from inner portion 408 to container 418 in a cross-flow direction, as shown by arrows 450, such that the liquid may be filtered and sterilized. In the exemplary embodiment, the liquid is channeled outwardly from inner portion 408 to outer portion 410. The liquid is then filtered and sterilized in outer portion 410. More specifically, in the exemplary embodiment, filter 414 prevents semi-liquid and/or solid particles, such as yeast, hops, or grain particles, that are dispersed within the liquid from being channeled therethrough. Further, conductive material 416 embedded within filter 414 facilitates the sterilization of the liquid at the same time. More specifically, the electrical energy transmitted from power supply 104 enables conductive material 416 to be electrically charged. Conductive material 416 generates and applies a pulsed electric field onto the liquid. Moreover, since container 418 is an anode, container enables the electrical energy to remain within container 418 and cylindrical tube 406. The electric field applies energy onto the liquid for each pulse. As such, micro-organisms or spores within the filtered liquid are terminated. The filtered and sterilized liquid is then channeled to container 418, wherein the liquid may remain and be stored until later use.

As compared to known systems, apparatus, and methods that are used to process liquids, the above-described liquid processing apparatus facilitates a liquid to be filtered and sterilized in the apparatus at the same time. More specifically, in an embodiment, the liquid processing apparatus includes a cylindrical tube that includes an inner portion configured to contain a liquid therein and an outer portion substantially circumscribing the inner portion. The outer portion includes a porous filter. A conductive assembly is coupled to the cylindrical tube, wherein the conductive assembly is configured to generate an electric field to apply on the liquid. The liquid is channeled from the inner portion of the cylindrical tube through the conductive assembly such that the liquid is filtered when the liquid is channeled through the porous filter and sterilized when the liquid is channeled through the conductive assembly. As such, the filtration process and the sterilization process occur together, and industrial systems, such as liquid or beverage industrial systems, will no longer need separate holding areas to perform the filtration and the sterilization. Accordingly, liquid processing by beverage industrial systems may no longer require a significant amount of time, energy, and resources.

Exemplary embodiments of systems, apparatus, and methods are described above in detail. The systems, apparatus, and methods are not limited to the specific embodiments described herein, but rather, components of the systems, apparatus, and/or steps of the method may be utilized independently and separately from other components and/or steps described herein. For example, the apparatus may also be used in combination with other systems and methods, and is not limited to practice with only a liquid or beverage industrial system as described herein. Rather, the exemplary embodiment can be implemented and utilized in connection with many other systems.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A liquid processing apparatus comprising:
a cylindrical tube comprising an inner portion configured to contain a liquid therein and an outer portion substantially circumscribing said inner portion, wherein said outer portion comprises a porous filter; and
a conductive assembly coupled to said cylindrical tube, wherein said conductive assembly is configured to generate an electric field to apply on the liquid, the liquid is channeled from said inner portion of said cylindrical tube through said conductive assembly such that the liquid is filtered when the liquid is channeled through said porous filter and sterilized when the liquid is channeled through said conductive assembly.

2. A liquid processing apparatus in accordance with claim 1, further comprising a container substantially circumscribing at least a portion of said cylindrical tube and configured to store the liquid therein when the liquid is filtered and sterilized.

3. A liquid processing apparatus in accordance with claim 2, wherein said conductive assembly comprises a plurality of rods positioned within said container such that said plurality of rods substantially circumscribe said cylindrical tube.

4. A liquid processing apparatus in accordance with claim 3, wherein said plurality of rods are fabricated from a conductive material.

5. A liquid processing apparatus in accordance with claim 1, wherein said conductive assembly comprises a plurality of rods positioned within said porous filter such that said plurality of rods substantially circumscribe said inner portion.

6. A liquid processing apparatus in accordance with claim 1, wherein said conductive assembly is configured to generate the electric field to apply the electric field in at least one of exponentially decaying pulses, square wave pulses, bipolar pulses, and oscillatory pulses on the liquid.

8. A liquid processing apparatus comprising:
a cylindrical tube comprising an inner portion configured to contain a liquid therein and an outer portion substantially circumscribing said inner portion, wherein said outer portion comprises a porous filter and a conductive material embedded within said porous filter, the liquid is channeled from said inner portion to said outer portion such that the liquid is filtered and sterilized when the liquid is channeled through said porous filter; and
a container substantially circumscribing at least a portion of said cylindrical tube, wherein said container is configured to receive the liquid after the liquid is channeled through said cylindrical tube.

9. An industrial system comprising:
a power supply configured to generate electrical energy; and
a liquid processing apparatus coupled to said power supply, said liquid processing apparatus comprising:
a cylindrical tube comprising an inner portion configured to contain a liquid therein and an outer portion substantially circumscribing said inner portion, wherein said outer portion comprises a porous filter; and
a conductive assembly coupled to said cylindrical tube and configured to receive electrical energy from said power supply, wherein said conductive assembly is further configured to generate an electric field to apply on the liquid, the liquid is channeled from said inner portion of said cylindrical tube through said conductive assembly such that the liquid is filtered when the liquid is channeled through said porous filter and sterilized when the liquid is channeled through said conductive assembly.

10. An industrial system in accordance with claim 9, wherein said liquid processing apparatus further comprises a container substantially circumscribing at least a portion of said cylindrical tube and configured to store the liquid therein when the liquid is filtered and sterilized.

11. An industrial system in accordance with claim 10, wherein said conductive assembly comprises a plurality of rods positioned within said container such that said plurality of rods substantially circumscribe said cylindrical tube.

12. An industrial system in accordance with claim 11, wherein said plurality of rods are fabricated from a conductive material.

13. An industrial system in accordance with claim 9, wherein said conductive assembly comprises a plurality of rods positioned within said porous filter such that said plurality of rods substantially circumscribe said inner portion.

14. An industrial system in accordance with claim 9, wherein said conductive assembly is configured to generate the electric field to apply the electric field in at least one of exponentially decaying pulses, square wave pulses, bipolar pulses, and oscillatory pulses on the liquid.

16. A method of processing a liquid, said method comprising:
providing a cylindrical tube coupled to a conductive assembly, wherein the cylindrical tube includes an inner portion and an outer portion that includes a porous filter substantially circumscribing the inner portion, and wherein the conductive assembly is configured to generate an electric field to apply on the liquid;
distributing the liquid within the inner portion of the cylindrical tube such that the liquid is contained therein; and
channeling the liquid from the inner portion through the conductive assembly such that the liquid is filtered when the liquid is channeled through the porous filter and sterilized when the liquid is channeled through the conductive assembly.

17. A method in accordance with claim 16, further comprising channeling the liquid to a container substantially circumscribing at least a portion of the cylindrical tube, wherein the container is configured to store the liquid therein when the liquid is filtered and sterilized.

18. A method in accordance with claim 17, wherein providing a cylindrical tube further comprises providing a cylindrical tube coupled to a conductive assembly that includes a plurality of rods positioned within the container such that the plurality of rods substantially circumscribe the cylindrical tube.

19. A method in accordance with claim 16, wherein providing a cylindrical tube further comprises providing a cylindrical tube coupled to a conductive assembly that includes a plurality of rods positioned within the porous filter such that the plurality of rods substantially circumscribe the inner portion.

20. A method in accordance with claim 16, further comprising transmitting electrical energy, via a power supply, to the conductive assembly.
